(19) United States
(12) Patent Application Publication
(10) Pub. No.: US 2011/0114705 A1
(43) Pub. Date: May 19, 2011

(54) Method for creating thermal bonds while minimizing heating of parts

(75) Inventor: Gregory P. Matis, Santa Barbara, CA (US)

(73) Assignee: Santa Barbara Infrared, Santa Barbara, CA (US)

(21) Appl. No.: 12/592,132

(22) Filed: Nov. 19, 2009

(51) Int. Cl. B23K 31/02

(52) U.S. Cl. 228/121; 228/124.5

(57) ABSTRACT

A method for making thermally conductive high aspect ratio large area contact between devices while reducing the heating of the devices. The method of the invention includes the use of reactive foils to solder two devices together at room temperature while imparting significantly less temperature rise and resultant residual stress in the bulk devices when compared with conventional reflow solder techniques.

### BACKGROUND OF THE INVENTION

1. Field of the Invention

This invention relates generally to the thermally conductive bonding of materials and more particularly thermally conductive bonding of materials that undergo temperature changes where said materials have different coefficients of thermal expansion.

2. Description of the Related Art

In some fields of optical and laser-electronics, and micro-electrical/mechanical devices the component size can be significantly large; e.g. greater than 625 mm². This is particularly true when dealing with arrayed devices such as imaging sensors, digital liquid crystal displays or attenuators, digital infrared emitters, laser diodes, and deformable mirrors that can be planar, have a curved or a polygonal surface.

Packaging a device typically requires a second component of adequate design and geometry to facilitate a device's operation and provide a means to integrate the device into a product. The device and package component are typically joined or bonded at some level. The bond is required to provide any or all of the following characteristics: mechanical adhesion, bond strength, thermal conductivity, and electrical conductivity; and not induce damage or affect required functionality of the device and package component while being exposed to environmental influences; specifically large changes in temperature during processing and operation.

When large parts are required to be joined using solders, epoxies, adhesives, or any two-phase materials, and thermal or electrical conductivity must be well maintained, the bond must be made such that the one part can expand or contract at a greater rate than the other one without damaging one or both of the parts and without disrupting the thermal or electrical conductivity of the bond during thermal excursion that can be as great as that from room temperature to cryogenic temperatures. Moreover there may be additional stresses built into the bond if it is formed at elevated temperatures. A method is therefore needed to bond surfaces together without raising the temperature of the surfaces so that the difference between bond-formation temperature and operating temperature is reduced, thereby reducing the stresses between the two surfaces at ambient.

In addition, there is a need for a way to form bonds between indium bump-bonded composite parts and a heatsink, device carrier or other substrate such that the temperature of the device away from the bonded surface itself is not raised above the Indium melting point of the bumps. This is characteristic of three dimensional device assemblies as multiple devices are vertically integrated through hybridization. More specifically, if one builds emitter arrays such as light emitting diodes (LED), laser diodes (LD), resistive emitters (family of microbolometers) that are then Indium bump bonded to read in integrated circuits (RIIC) a method is needed for bonding these composite devices to substrates without damaging or severely deforming the Indium bump bonds.

Use of high strength bonding materials; e.g. AuSn, can reduce the likelihood of fatigue of the joint and offer excellent heat transfer; however high conventional reflow process temperatures for this material makes it unsuitable for joining temperature sensitive devices or cases where Indium is used to hybridize semiconductor and opto-electronic devices.

Conventional reflow processes using popular bonding materials such as Pb, PbSn, and leadfree solders have higher process temperatures than Indium and subject the Indium to rapid oxidation which can compromise existing bonds resulting in low device relialbility due to temperature induced motion or stresses.

Room temperature curing conductive adhesives, using a gap filler medium, expose the surfaces to be joined to significantly smaller temperature differentials reducing the aforementioned risk to the existing Indium bond structures or to temperature sensitive devices. Unfortunately these adhesives or epoxies typically do not exhibit the heat transfer performance of solder or two-phase alloys.

Known methods for performing this type of assembly at room temperature are described by Snyder et al; ref U.S. Pat. Nos. 7,202,553 and 7,176,106. However in these patents the method described is applied to deposition of the reactive foil, bonding of large scale integrated patterned wafers using reactive foil, and subsequent singulation of the joined wafers. The assembly process describes direct bonding to deposited metal lines on the patterned wafers. While this is satisfactory for some forms of read-out-integrated circuits (ROIC) or logic devices that are less stress sensitive more highly integrated or hybridized devices such as optical focal plane detector ROIC's or resistive emitter read-in-integrated circuits (RIIC) typically are highly sensitive to induced stress and changes in planarity; so direct bonding to surface metal is not desirable. Compliance must be designed into the joint by use of conductive solder balls, posts, or a continuous solder joint which can be applied in a number of vacuum or electrolytic deposition techniques; however, in order to finalize the bond the assembled devices must then be elevated in temperature above the solidus of the solder.

In view of the foregoing, it would be desirable to provide a method of fabricating a thermally and electrically conductive bond between large area temperature sensitive devices, their packages, or other surfaces that allows assembly or bonding of said devices at near ambient temperatures while imparting no residual stress into the devices or altering other established interfaces from prior steps in the assembly using solder as the interface medium.

### References

| Patent | Title | Author |
|---|---|---|
| 7,202,553 | Wafer bonding using reactive foils for | Snyder et al |
| | massively parallel micro-electromechanical | |
| | systems packaging | |
| 7,176,106 | Wafer bonding using reactive foils for | Snyder et al |
| | massively parallel micro-electromechanical | |
| | systems packaging | |

### Other References

E. Helan, D. Van Heerden—Localized Heat Source for the Future (Reactive NanoFoils); Micro and Nano; Apr. 2007, Vol. 12, No. 4.

### SUMMARY OF THE INVENTION

The present invention solves the above-described deficiencies by providing a continuous/semi-continuous large area, thermal and electrical conductive, ambient temperature solder bond for electronic/optical-electronic devices. The method reduces the heating of either of the parts thereby have the dual advantages of reducing the difference between bond-formation and operating temperatures and, not raising device temperatures too much during the bonding process and thereby avoiding damage to temperature sensitive parts.

### BRIEF DESCRIPTION OF THE DRAWINGS

The foregoing and other features, aspects and advantages of the present invention will become better understood with reference to the accompanying drawings in which:

FIG. 1 is a schematic view of the Assembled Component Bond Interface

FIGS. 2-3 are schematic views illustrating steps of an embodiment of the process of the invention for using reactive foils to form a continuous bond between two substrates at ambient temperature.

### DETAILED DESCRIPTION OF THE INVENTION

FIG. 2 shows the two substrates 100 and 200 to be joined separated by a thin multi-layer nano-engineered foil of reactive metal 400. The reactive metal foils 400 are of Ni—Al or Ti—Al class of materials; examples of which are produced by Reactive NanoTechnologies, Hunt Valley, Md. The foils 400 can be made as preforms of various sizes and thickness; and are engineered to produce a non-explosive, nontoxic, single-use, highly controllable exothermic reaction that provides heat selectively to surfaces intimate to the foil 400. The reaction front travels along the foil 400 at speeds between 1- 30 m/sec, raising the local temperature from 25° C. to >1000° C. in <10 msec. Self-propagating reactions in metallic multi-layer foils 300 are driven by a reduction in chemical bond energy. With a small thermal pulse, atoms diffuse normal to the layering, and Al—Al and Ni—Ni bonds are exchanged for Al—Ni bonds. This local bond exchange produces a large quantity of heat that is conducted down the foil and facilitates more atomic mixing.

In FIG. 2, both surfaces to be joined are pretreated with a solder alloy 300. In or In alloy is preferred if either of the devices is temperature sensitive, must operate at cryogenic temperatures, or has existing Indium bond structures applied to some other surface removed from the area to be bonded herein.

In FIG. 3, the two solder 300 treated surfaces are mated to the foil 400 using dead weight. In one embodiment, sacrificial masks of polyimide are used to cover sensitive features that are not to be wetted with solder flash ejected at the solder/foil interface. Electrical leads 410 designed into the reactive foil allow connection to an electrical supply used as the igniter. Upon reaction, the thermal energy locally melts the In solder 300 intimate to the foil 400, within 90 microns on either side of the foil 400, temperatures are typically less than 250° C. which is above In solidus; and at 200 microns either side are less than 100° C. which is below In solidus. Solder 300 gap thickness is desired to be greater than 50 microns and can be as large as hundreds of microns. The bulk temperature of either substrate 100, 200 which affects their overall size due to thermal expansion varies less than 10° C. from ambient with actual temperature defined by the thermal properties of the respective substrates and bulk solder 300. The process does not require use of fluxes and when the reaction is complete the foil 400 is intermixed with In solder 300 providing excellent interface adhesion, thermal and electrical conductivity on the order of the In solder 300, and retaining the cryogenic ductility necessary for stress/strain compensation of dissimilar substrate materials experiencing large operational temperature differentials. The process can be performed in ambient atmosphere with no special precautions.

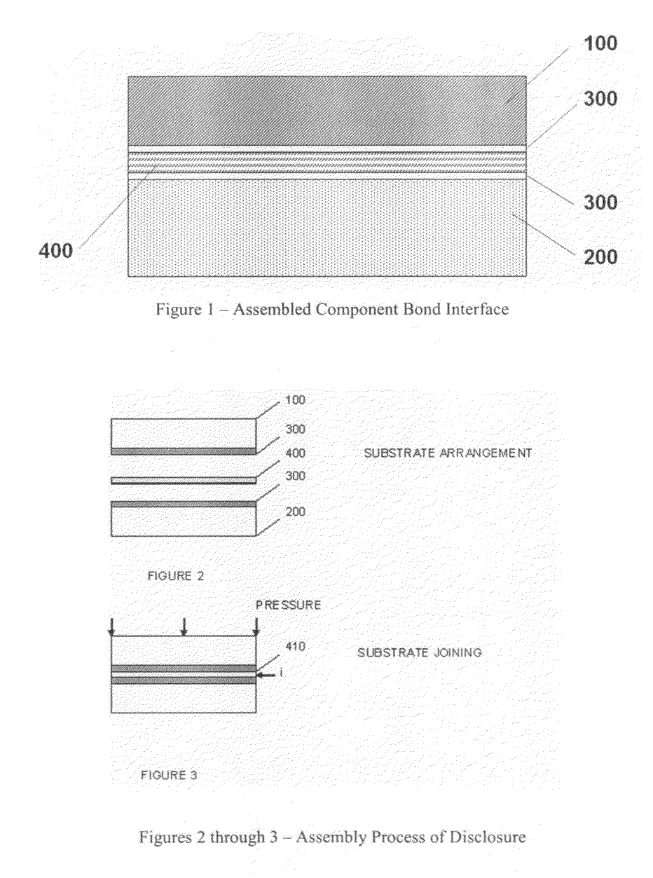

In FIG. 1, the final assembled device and its mating substrate are illustrated. Upon termination of the process the residual elements of the reactive foil are incorporated into the bond as a matrix of the bulk solder and micro-fragments of the foil.

In one embodiment, one of the substrates 100 is a read in integrated circuit (RIIC) that has resistive emitters hybridized to the opposite side of the RIIC to be joined and the second substrate is a ceramic chip-carrier 200. In another embodiment, one of the

What is claimed is:

1. A method for forming a thermally conductive bond between a first material and a second material, comprising: contacting a first surface of a reactive foil to a first material surface; contacting a second surface of a reactive foil to a second material surface; and causing said reactive foil to produce an exothermic reaction that causes the material comprising the foil to flow and bond to the first and second material surfaces.

2. The method of claim 1 in which the first material surface is a conductively coated semiconductor die and the second material surface is a metal.

3. The method of claim 1 in which the first material surface is a conductively coated semiconductor die and the second surface is a ceramic.

4. The method of claim 1 in which dispersed spacers are included in the reactive foil to maintain a fixed thickness of the reactive foil.

5. The method of claim 1 in which the first or second material surface has a structure into which the reactive foil flows when melted by the exothermic reaction.

6. The method of claim 1 in which the first material surface is the conductively coated surface of a read-in-integrated circuit (RIIC) and the second surface is a metal.

7. The method of claim 1 in which the first material surface is a conductively coated active optical electronic device and the second surface is a read-in-integrated circuit (RIIC).

8. The method of claim 6 in which the first side of a read-in-integrated circuit is bonded to a second material surface and has an additional structure that is bonded to it with Indium bump-bonds.

9. The method of claim 1 in which the first material surface is a conductively coated laser diode device and the second surface is a metal.
